(19) United States
(12) Patent Application Publication
(10) Pub. No.: US 2021/0277909 A1
(43) Pub. Date: Sep. 9, 2021

(54) VACUUM PUMP, PARTICULARLY FOR APPARATUSES FOR FOOD PRESERVATION

(71) Applicant: Marziano SALVARO, Negrar (IT)

(72) Inventor: Marziano SALVARO, Negrar (IT)

(21) Appl. No.: 17/190,930

(22) Filed: Mar. 3, 2021

(30) Foreign Application Priority Data
Mar. 4, 2020 (IT) 102020000004513

(51) Int. Cl. F04D 27/00; F04D 25/06; B65B 31/04; B65B 25/00; A23L 3/00; A23L 3/015

(52) U.S. Cl. CPC F04D 27/004; F04D 25/06; B65B 31/04; A23V 2002/00; A23L 3/001; A23L 3/0155; B65B 25/001

(57) ABSTRACT

A vacuum pump, particularly for apparatuses for food preservation, which includes a pump body, the peculiarity of which is that it includes a permanent-magnet motor with variable rotation rate which is adapted to control the pump, and an electronic power and control board, controlled by the permanent-magnet motor with variable rotation rate.

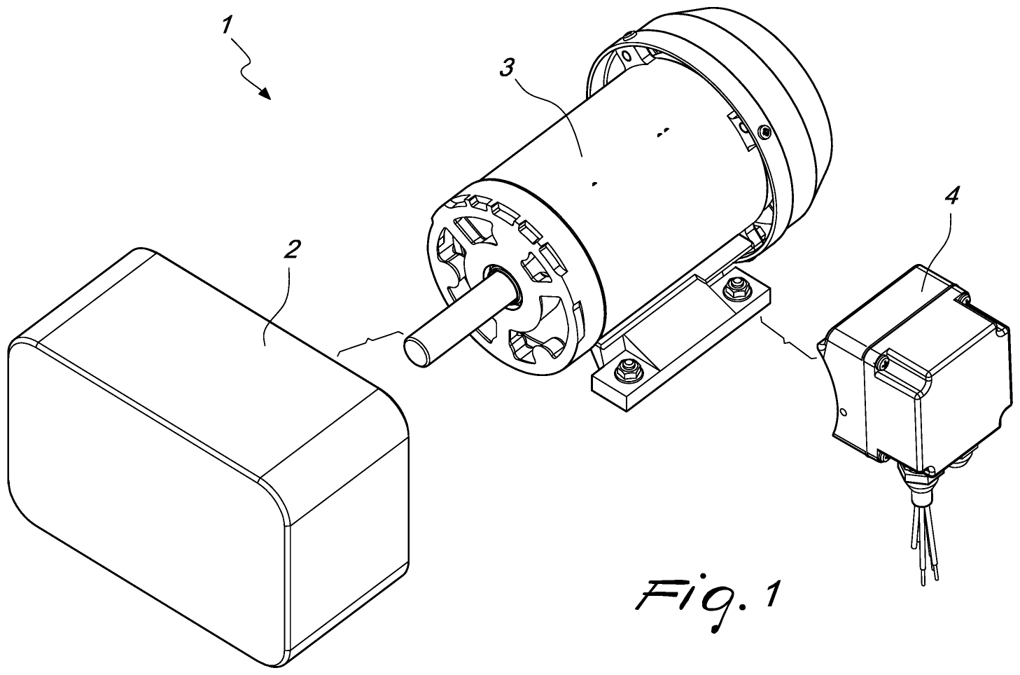

### CROSS REFERENCE TO RELATED APPLICATIONS

This application is related to and claims the benefit of Italian Patent Application No. 102020000004513, filed on Mar. 4, 2020, the contents of which are incorporated herein by reference in their entirety.

### TECHNICAL FIELD

The present disclosure relates to a vacuum pump, particularly for apparatuses for food preservation. More specifically, the disclosure relates to a vacuum pump, particularly for apparatuses for the preservation of food both cooked and raw.

### BACKGROUND

As is known, apparatuses for professional and domestic use, which generate a level of vacuum internally in order to improve the preservation of cooked and raw foods, are characterized by a vacuum generation system which is commonly constituted by a container, which becomes hermetically sealed, a channel system designed for the circulation of air, a vacuum pump, an alternating current asynchronous electric motor and, finally, a sealing system.

The operation of the system is ensured by numerous solenoid valves, and by sensors and actuators controlled by firmware that resides in an electronic power board which is generally connected also to an electronic user interface board which is provided with a display.

Usually, foods that are to be subjected to the vacuum process are placed inside sealable plastic containers.

The foods can be introduced both hot and cold into the apparatus for vacuum preservation. The vacuum process inevitably extracts a small amount of water from the foods along with biochemical liquids which, in the form of vapor, transport particles of biological material of various composition. The amount of liquid extracted and of biological material transported is proportional to the temperature of the food, to the surface humidity of the food and to the diffusivity characteristic of the moist part of the food.

The vacuum generation process is very rapid and, in the short length of time for which the pump is connected to the container, it sucks out, together with the air, vapor which entrains particles of biological material along with it.

The inevitable effect of transfer is that water, biochemical liquids and biological material even in the form of dry particulate, accumulate inside the pump. The mixture aggregates without mixing completely with the lubrication and cooling oil of the pump itself, by virtue of additives added to the oil.

The presence of water and of biological substances with different heat exchange capacities alters the characteristics of the oil, and furthermore generates oxidized components, to the point where the physical characteristics of the oil deteriorate significantly, in particular its viscosity, dielectric capacity and thermal conductivity.

The presence of water and of biochemical liquid that have a boiling point different from that of oil alters the heat transfer coefficient of the oil with tangible effects on the lifetime and on the seal of the vacuum pump.

### SUMMARY

The aim of the present disclosure is to provide a vacuum pump, particularly for apparatuses for food preservation, that makes it possible to optimize, within a defined torque range, any breakaway torque demand, during operation, and cutoff torque demand.

Within this aim, the present disclosure provides a vacuum pump, particularly for apparatuses for food preservation, that makes it possible to evaluate the variation of the viscosity of the lubricant oil during operation.

The present disclosure also provides a vacuum pump, particularly for apparatuses for food preservation, that makes it possible to create customized cycles that are slow, fast, mixed, adaptable, and related combinations thereof.

The present disclosure further provides a vacuum pump, particularly for apparatuses for food preservation, that makes it possible to run a malfunction diagnostic procedure in the absence of sensors.

The present disclosure also provides a vacuum pump, particularly for apparatuses for food preservation, that is highly reliable, has a reduced bulk with respect to conventional pumps, is easily and practically implemented, and has a low cost.

This aim and these and other advantages which will become better apparent hereinafter are achieved by providing a vacuum pump, particularly for apparatuses for food preservation, which comprises a pump body, characterized in that it comprises a permanent-magnet motor with variable rotation rate which is adapted to control said pump, and an electronic power and control board, controlled by said permanent-magnet motor with variable rotation rate.

### BRIEF DESCRIPTION OF THE DRAWING

Further characteristics and advantages of the disclosure will become better apparent from the detailed description of a preferred, but not exclusive, embodiment of the pump according to the disclosure, illustrated by way of non-limiting example in the accompanying drawings, wherein the single FIGURE is an exploded perspective view of the pump according to the present disclosure.

### DETAILED DESCRIPTION OF THE DRAWING

With reference to the FIGURE, the pump according to the present disclosure, generally designated by the reference numeral 1, comprises a pump body 2, a permanent-magnet motor with variable rotation rate 3 which is adapted to control the pump body 2, and an electronic power and control board 4 which is designed to control the permanent-magnet motor with variable rotation rate 3.

Conveniently, the electronic board 4 is capable of controlling the torque exerted by the motor by deriving from such information an evaluation of the variation of the viscosity of the oil of the pump, as a function of the variation of the resistive torque.

A change in power absorbed by the motor is read by the electronic board 4 as a change in the current generated by the change in the magnetic field, and is therefore easily measurable even for small changes, without the presence of any dedicated sensor.

It has been found that under operating conditions the vacuum pump with permanent-magnet motor with variable rotation rate absorbs approximately 36% less than an identical pump with a conventional asynchronous motor.

Even at breakaway, the pump with permanent-magnet motor with variable rotation rate absorbs approximately 30% less power.

Furthermore, the starting of the pump can be controlled with a ramping-up of current or with a change in rotation frequency which, for the same torque required, optimizes the power yielded.

In general, the torque of the pump, by virtue of the presence of the permanent-magnet motor with variable rotation rate, can be optimized for all the load conditions of the pump, thus optimizing the overall operation thereof.

The presence of a permanent-magnet motor with variable rotation rate with a corresponding power and control board 4 makes it possible, via control algorithms, to control functions that are usually entrusted to the presence of sensors.

Furthermore, it is possible to obtain a reduction in size of a single vacuum pump, electric motor and electronic board compared to a vacuum pump fitted with a conventional asynchronous motor.

In general, the power and control board is configured to define start-stop profiles with ramping-up or ramping-down for the permanent-magnet motor with variable rotation rate.

In practice it has been found that the pump according to the disclosure fully achieves the set aim and objects, in that it makes it possible to have an optimized operation by virtue of the presence of a permanent-magnet motor with variable rotation rate with an electronic power and control board.

The pump thus conceived is susceptible of numerous modifications and variations, all of which are within the scope of the appended claims.

Moreover, all the details may be substituted by other, technically equivalent elements.

In practice, the materials used, as well as the contingent shapes and dimensions, may be any according to the requirements and to the state of the art.

1. A vacuum pump comprises a pump body, comprising a permanent-magnet motor with variable rotation rate which is adapted to control said pump, and an electronic power and control board, controlled by said permanent-magnet motor with variable rotation rate.

2. The pump according to claim 1, wherein said electronic power and control board is configured to use a variation of viscosity of an oil of the pump as a function of variation of the resistive torque.

3. The pump according to claim 1, wherein said electronic power and control board is configured to read variation in power absorbed by said permanent-magnet motor with variable rotation rate as a variation of a current generated by a variation of the magnetic field.

4. The pump according to claim 1, wherein said electronic power and control board is configured to optimize a torque demand of said permanent-magnet motor with variable rotation rate.

5. The pump according to claim 1, wherein said electronic power and control board is configured to define start-stop profiles with ramping-up or ramping-down for said permanent-magnet motor with variable rotation rate.

6. An apparatus for food preservation, comprising a vacuum pump according to claim 1.
